(19) United States
(12) Patent Application Publication
(10) Pub. No.: US 2010/0081563 A1
(43) Pub. Date: Apr. 1, 2010

(54) Adhesion and coating integrity of washcoats and overcoats

(76) Inventors: Andrew Edgar-Beltran, Ventura, CA (US); Stephen J. Golden, Santa Barbara, CA (US); Mark Jarand, Newbury Park, CA (US); Chi Le, El Cerrito, CA (US)

Correspondence Address: REED SMITH LLP, 2500 ONE LIBERTY PLACE, 1650 MARKET STREET, PHILADELPHIA, PA, 19103, US

(21) Appl. No.: 12/286,118

(22) Filed: Sep. 26, 2008

(51) Int. Cl. B01J 29/04; B01J 31/04; B01J 21/12

(52) U.S. Cl. 502/62; 502/150; 502/172; 502/170

(57) ABSTRACT

The present invention pertains to the addition of a carboxylic acid, preferably formic acid or acetic acid, to a washcoat and/or overcoat slurry to improve the properties of the slurry, including adhesion of the slurry to a substrate. The present invention provides for the reduction in oxide solid loss, increase in oxide solid pickup, and a more efficient method of producing washcoat and/or overcoat slurries.

### TECHNICAL FIELD OF THE INVENTION

The present invention relates to improving adhesion of washcoats to substrates and overcoats to washcoats by adding one or more carboxylic acid, preferably formic acid, to a slurry comprising oxide solids to make a catalyst system (or in the process of making a catalyst system). The present invention also relates to improving the integrity of washcoats and/or overcoats, to strengthening the layers of the washcoat and/or overcoat, and to achieving less cracking of the layers.

### BACKGROUND OF THE INVENTION

Catalysts in catalytic converters have been used to decrease the pollution caused by exhaust from various sources, such as automobiles, utility plants, processing and manufacturing plants, airplanes, trains, all terrain vehicles, boats, mining equipment, and other engine-equipped machines. A common catalyst used in this way is the three-way catalyst (“TWC”). The TWC works by converting carbon monoxide, hydrocarbons, and nitrogen oxides into less harmful compounds or pollutants. Specifically, a TWC works by simultaneously reducing the nitrogen oxides to nitrogen and oxygen, oxidizing carbon monoxide to less harmful carbon dioxide, and oxidizing unburnt hydrocarbons to carbon dioxide and water.

A major problem with manufacturing catalyst systems is achieving the proper adhesion of a washcoat to a substrate and/or adhesion of a washcoat to an overcoat. Factors affecting adhesion of a washcoat to a substrate and/or of an overcoat to a washcoat include, but are not limited to, substrate cell density, substrate wall thickness, substrate porosity, washcoat and overcoat particle size and particle size distribution, additive or dopant properties and amounts, washcoat and/or overcoat loading (thickness of layer), alumina to oxygen storage material (OSM) ratio, and treating conditions. The lengthy process of creating a suitable washcoat and/or overcoat slurry includes the addition or removal of water, which is minimized or eliminated by the present invention.

Currently, ammonia is used as a rheological aid in creating suitable slurries. However, with the present invention the need for ammonia for rheological adjustment is reduced or eliminated because carboxylic acids work both as a rheological aid and an adhesion aid. This reduced costs and the difficulty of ammonia storage.

Alumina boehmite binders have been used in the prior art to help with the adhesion of washcoats to substrates. The alumina boehmite binders have high amounts of hydroxyl covalent bonding sites, which aid adhesion. They show some effectiveness in certain formulations, but do not show progressive and reproducible improvement like the present invention. Binders are one option; however the present invention provides a new and better way of improving washcoat and/or overcoat adhesion even when binders are eliminated.

The present invention solves the problem of coating adhesion loss and low oxide solids adhesion rate on substrates. The present invention provides a more efficient method of producing slurries for catalyst production because a higher solids pickup can be achieved with the same slurry conditions (e.g., percent solids, viscosity, and dose mass, meaning the amount of slurry applied (which may be more or the same as the amount of solids deposited on the substrate)) when one or more carboxylic acid is added. Further, the present invention allows for the use of catalyst formulations that have good catalytic activity, but have otherwise poor adhesion properties without the present invention.

### SUMMARY OF THE INVENTION

One embodiment of the present invention pertains to a method for improving adhesion of a washcoat to a substrate, comprising adding a carboxylic acid to a slurry, wherein the total carboxylic acid added is between about 0.1% to about 5% of a total oxide solid content of the slurry; and exposing the substrate to the slurry. Another embodiment of the present invention pertains to a catalyst system, comprising a substrate and a washcoat. The washcoat is coupled with the substrate and the washcoat is made by the process comprising adding a carboxylic acid to a slurry comprising an oxide solid and exposing the substrate to the slurry. Further, the carboxylic acid is between about 0.1% to about 5% of a total oxide solid content of the slurry. The substrate is any substrate suitable for TWC as known in the art and described below in this specification, preferably, without limitation, cordierite.

Another embodiment of the present invention pertains to a slurry for depositing a catalyst on a substrate, comprising an oxide solid and a carboxylic acid, wherein the carboxylic acid is between about 0.1% to about 5% of a total oxide solid content of the slurry.

Another embodiment of the present invention pertains to a method for improving adhesion of an overcoat to a washcoat, comprising adding a carboxylic acid to a washcoat slurry and exposing a substrate to the washcoat slurry. Further, the carboxylic acid is between about 0.1% to about 5% of a total oxide solid content of the washcoat slurry.

Another embodiment of the present invention pertains to a method for improving adhesion of an overcoat to a washcoat, comprising adding a carboxylic acid to an overcoat slurry and exposing a washcoat to the overcoat slurry. Further, the carboxylic acid is between about 0.1% to about 5% of a total oxide solid content of the overcoat slurry.

Another embodiment pertains to a method for improving adhesion of an overcoat to a washcoat, comprising adding a carboxylic acid to a washcoat slurry and/or an overcoat slurry, exposing a substrate to the washcoat slurry, and exposing the washcoat to the overcoat slurry. Further, the carboxylic acid is between about 0.1% to about 5%, preferably about 0.1% to about 3%, of a total oxide solid content of the washcoat slurry and/or between about 0.1% to about 5%, preferably about 0.1 to about 3% of a total oxide solid content of the overcoat slurry.

Another embodiment of the present invention pertains to a method for improving adhesion of a slurry to a substrate, comprising adding a carboxylic acid to a slurry comprising an oxide solid and exposing the substrate to the slurry, wherein the carboxylic acid is between about 0.1% to about 5% of a total oxide solid content of said slurry and wherein about 120 g/L to about 180 g/L of the slurry is applied to a substrate.

According to an embodiment, the carboxylic acid comprises one or more selected from the group consisting of glycolic acid, glyoxylic acid, carbonic acid, oxalic acid, acetic acid, and formic acid, preferably acetic acid or formic acid. The total carboxylic acid added may be between about 0.1% to about 5% of a total oxide solid content of the washcoat and/or overcoat. For formic acid, the preferred total amount added may be between about 0.1% and about 3% of the total oxide solid content of the washcoat and/or overcoat slurry, more preferably 0.8% and about 1.5% of the total oxide solid content. For acetic acid, the preferred total amount added may be between about 0.1% and about 5% of the total oxide solid content of the washcoat and/or overcoat slurry, more preferably about 1% to about 3% of the total oxide solid content.

### BRIEF DESCRIPTION OF THE DRAWINGS

FIG. 1 shows the formation of bubbles in a washcoat comprising formic acid.

### DEFINITIONS

The following definitions are provided to clarify the invention.

The term “carboxylic acid” is defined in this specification to mean one or more of: formic acid, glycolic acid, glyoxylic acid, carbonic acid, and oxalic acid.

The term “catalyst” is defined in this specification to mean a catalyst for decreasing the amount of nitrogen oxide, hydrocarbon, carbon monoxide, and/or sulfur comprising at least a platinum group metal and/or a transition metal.

The term “washcoat” is defined in this specification to mean a coating comprising one or more oxide solids that is coupled with a substrate.

The term “overcoat” is defined in this specification to mean a coating comprising one or more oxide solids that is coupled with a substrate and a washcoat.

The term “oxide solid” is defined in this specification to mean one or more selected from the group consisting of a carrier material oxide, a catalyst, and mixtures thereof.

The term “carrier material oxide” is defined in this specification to mean materials used for providing a surface for at least one catalyst and comprises one or more selected from the group consisting of oxygen storage material, aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof.

The term “oxygen storage material” is defined in this specification to mean materials that can take up oxygen from oxygen-rich feed streams and release oxygen to oxygen-deficient feed streams. The oxygen storage material comprises one or more oxides selected from the group consisting of cerium, zirconium, lanthanum, yttrium, lanthanides, actinides, and mixtures thereof.

The term “slurry” is defined in this specification to mean a liquid suspension comprising water and at least one oxide solid.

The term “catalyst system” is defined in this specification to mean a substrate, a washcoat, and optionally an overcoat.

The term “substrate” is defined in this specification to mean any material known in the art for supporting a catalyst and can be of any shape or configuration that yields a sufficient surface area for the deposit of the washcoat and/or overcoat, including, but not limited to honeycombs, pellets, or beads.

The term “platinum group metal” or “PGM” is defined in this specification to mean one or more of platinum, palladium, ruthenium, iridium, osmium, and rhodium.

The term “transition metal” is defined in this specification to mean the transition metals of the periodic table excluding the platinum group metals, and including scandium, titanium, vanadium, chromium, manganese, iron, cobalt, nickel, copper, zinc, yttrium, zirconium, niobium, molybdenum, technetium, ruthenium, silver, cadmium, hafnium, tantalum, tungsten, rhenium, gold, mercury, rutherfordium, dubnium, seaborgium, bohrium, hassium, meitnerium, ununnilium, unununium, ununbium, and gallium.

The term “coupled with” is defined in this specification to mean the washcoat and/or overcoat is in a relationship with the substrate or each other, such that they may be directly in contact with each other; or they may be associated with each other, but there may be something in between each of them, e.g. the overcoat may be coupled with a substrate, but a washcoat may be in between the substrate and the overcoat.

The term “depositing,” “deposited,” or “deposit(s)” is defined in this specification to include, without limitation, placing, adhering, curing, coating (such as vacuum coating), spraying, dipping, painting and any known process for coating a film on a substrate.

The term “treating,” “treated,” or “treatment” is defined in this specification to include, without limitation, precipitation, drying, firing, heating, evaporating, calcining, or mixtures thereof.

All percentages discussed herein are weight percent unless otherwise indicated.

### DETAILED DESCRIPTION OF PREFERRED EMBODIMENTS

Washcoat and/or overcoat adhesion may be controlled by several parameters, including but not limited to, the selection of slurry composition, slurry particle size, distribution of particles in the slurry, and process settings. The present invention provides another type of control over adhesion of washcoat and/or overcoat slurries using carboxylic acids. The present invention provides for better adhesion of the oxide solids in the various slurries reduction in oxide solid loss, increase in oxide solid pickup and, a more efficient method of producing slurries.

Substrates

The substrate used with the present invention may be, without limitation, a refractive material, a ceramic substrate, a honeycomb structure, a metallic substrate, a ceramic foam, a metallic foam, a reticulated foam, or suitable combinations, where the substrate has a plurality of channels and at least the required porosity for the catalytic purpose. Porosity is substrate dependent as is known in the art. Additionally, the number of channels may vary depending upon the substrate used as is known in the art. The channels found in a monolith substrate are described in more detail below. The type and shape of a suitable substrate would be apparent to one of ordinary skill in the art. Preferably, all of the substrates, either metallic or ceramic, offer a three-dimensional support structure.

In one embodiment, the substrate may be in the form of beads or pellets. The beads or pellets may be formed from, without limitation, alumina, silica alumina, silica, titania, mixtures thereof, or any suitable material. In another embodiment, the substrate may be, without limitation, a honeycomb substrate. The honeycomb substrate may be a ceramic honeycomb substrate or a metal honeycomb substrate. The ceramic honeycomb substrate may be formed from, for example without limitation, sillimanite, zirconia, petalite, spodumene (lithium aluminum silicate), magnesium silicates, mullite, alumina, cordierite (e.g. Mg₂Al₄Si₅O₁₈), other alumino-silicate materials, silicon carbide, aluminum nitride, or combinations thereof, preferably cordierite. Other ceramic substrates would be apparent to one of ordinary skill in the art.

If the substrate is a metal honeycomb substrate, the metal may be, without limitation, a heat-resistant base metal alloy, particularly an alloy in which iron is a substantial or major component. The surface of the metal substrate may be oxidized at elevated temperatures above about 1000° C. to improve the corrosion resistance of the alloy by forming an oxide layer on the surface of the alloy. This oxide layer on the surface of the alloy may also enhance the adherence of a washcoat to the surface of the monolith substrate.

In one embodiment, the substrate may be a monolithic carrier having a plurality of fine, parallel flow passages extending through the monolith. The passages can be of any suitable cross-sectional shape and/or size. The passages may be, for example without limitation, trapezoidal, rectangular, square, sinusoidal, hexagonal, oval, or circular, although other shapes are also suitable. The monolith may contain from about 9 to about 1200 or more gas inlet openings or passages per square inch of cross section, although fewer passages may be used.

The substrate can also be any suitable filter for particulates. Some suitable forms of substrates may include, without limitation, woven filters, particularly woven ceramic fiber filters, wire meshes, disk filters, ceramic honeycomb monoliths, ceramic or metallic foams, wall flow filters, and other suitable filters. Wall flow filters are similar to honeycomb substrates for automobile exhaust gas catalysts. They may differ from the honeycomb substrate that may be used to form normal automobile exhaust gas catalysts in that the channels of the wall flow filter may be alternately plugged at an inlet and an outlet so that the exhaust gas is forced to flow through the porous walls of the wall flow filter while traveling from the inlet to the outlet of the wall flow filter.

Washcoat

A washcoat may be formed on a substrate by suspending the carrier materials in water to form a slurry and placing (placing includes but is not limited to depositing, adhering, curing, coating, and any known coating processes to coat a film on a substrate) the slurry on the substrate as a washcoat. Any washcoats known in the art may be used with the present invention, preferably a washcoat comprising little to no platinum group metal, preferably no platinum group metals. See U.S. application Ser. No. 12/215,694, which is incorporated herein by reference. The total amount of platinum group metals in the slurry may range between about 0.01% (weight percent of the slurry) to about 0.20% but preferably 0%.

The present invention allows better adhesion of washcoats to substrates and overcoats. This is accomplished by the addition of a carboxylic acid, preferably formic acid or acetic acid.

Ethylene glycol is known to break down into five different acids in the presence of alumina, including glycolic, glyoxylic, carbonic, oxalic, and formic acid. Wheeler, et al., “Technical Insights into Uninhibited Ethylene Glycol,” Process Cooling & Equipment, July/August 2002, which is incorporated herein by reference.

Formic acid is one ingredient used in colloidal alumina powders, which are used as binders. In alumina binders, the formic acid (or other acid) is used to disperse and dissolve the alumina to a colloidal state. In contrast, when formic acid or another carboxylic acid is added directly to a slurry, it is encountering pre-aged alumina at much higher particle sizes, as well as OSM powder.

The most commonly used binder materials are colloidal acid or water dispersible alumina powders. They are typically about 70-80% alumina, about 1% acid (formic acid or other acid), and otherwise primarily bound water (with the hydroxyl groups in and/or on the alumina). Being colloidal, the particle size when dispersed is much smaller than the other powders in the slurries. They also have very high surface area and a high level of surface hydroxyl groups, all of which helps them help bond between the larger slurry particles.

Carboxylic acids are strong reducing agents and when used in slurries with high platinum group metal content, will react with and chemically reduce the platinum group metal. As such, the use of a carboxylic acid in the present invention is preferably with slurries comprising little or no platinum group metals. Carboxylic acids, especially formic acid and acetic acid, have surprisingly been found to be powerful washcoat slurry modifiers. The physical properties of a washcoat and/or overcoat slurry are changed with the addition of formic acid and/or acetic acid such that the rheology of the slurry is improved, by increasing oxide solid pickup on a substrate, and better coating adhesion of a washcoat to a substrate or an overcoat.

According to an embodiment, the amount of carboxylic acid added to a slurry is between about 0.1% to about 5% of a total of the oxide solid content of a washcoat and/or overcoat. In one embodiment, the amount of formic acid added to a slurry is between about 0.1% to about 3% of a total oxide solid content, preferably about 0.8% to about 1.5%. In one embodiment, the amount of acetic acid added to a slurry is between about 0.1% to about 5% of a total oxide solid content, preferably about 1% to about 3% of a total oxide solid content.

For standard sized substrates, it takes approximately about 80 g/L to about 200 g/L, preferably 120 g/L to 180 g/L of a washcoat slurry to achieve a good coating of a substrate with a washcoat.

According to an embodiment, a lower percentage than the ideal or suitable oxide solid content of a slurry according to the prior art may be used to achieve sufficient coating of a substrate with a washcoat. For example, if an ideal percentage of oxide solid in the prior art is about 49%, 47% oxide solid may be used to achieve a sufficient coating of the washcoat on a substrate when the present invention is employed. Being able to use a larger range of oxide solid percentages in the slurry reduces the amount and time of processing of the slurry necessary to achieve the needed amount of oxide solid content and a suitable slurry.

Typically, when an acid is added to a slurry, the viscosity of the washcoat and/or overcoat slurry decreases. However, surprisingly and contrary to this known effect, the addition of a carboxylic acid, such as formic acid or acetic acid, causes the viscosity of the slurry to increase (becomes thicker). The viscosity of a slurry increases as more formic acid or acetic acid is added. The primary purpose of increasing viscosity is as a processing aid. In an embodiment, the slurries are typically adjusted and maintained at between about 15° C. to about 25° C., preferably about 20° C. A sample of the slurry is taken from the vessel under good mixing conditions and measured using a viscometer, typically with a Brookfield viscometer Model RVDV-II, using a LV-2 spindle. The viscosity in an embodiment is about 500 cP to about 3000 cP at 60 rpm.

According to an embodiment, a catalyst used with the present invention comprises the following components: Washcoat (slurry)-Aluminum (28.4%), Lanthanum (5.1%), Zirconium (17.2%), Cerium (10.1%), Yttrium (1.7%), and Neodymium (1.9%); Impregnation (solution applied to the Washcoat)-Palladium (0.208%), Cerium (1.48%), Neodymium (0.17%), and Barium (19.38%); and Overcoat (slurry)-Rhodium (0.33%); Zirconium (17.1%), Cerium (10.0%), Lanthanum (5.1%), Yttrium (1.66%), Neodymium (1.87%); and Aluminum (28.2%). In this specification, the percentages given for the catalyst embodiments are for the metal content of the materials, and therefore do not usually total to 100% (without limitation, many of the materials are present as oxides). Formic acid is added to one or both slurries in accordance with the invention.

In another embodiment, a catalyst used with the present invention comprises the following components: Washcoat (slurry)-Platinum (0.034%), Rhodium (0.034%), Aluminum (24.43%), Lanthanum (1.66%), Zirconium (21.58%), Cerium (13.06%), Neodymium (2.08%), Praseodymium (2.01%), and Barium (1.17%). Formic acid is added to one or both slurries in accordance with the invention.

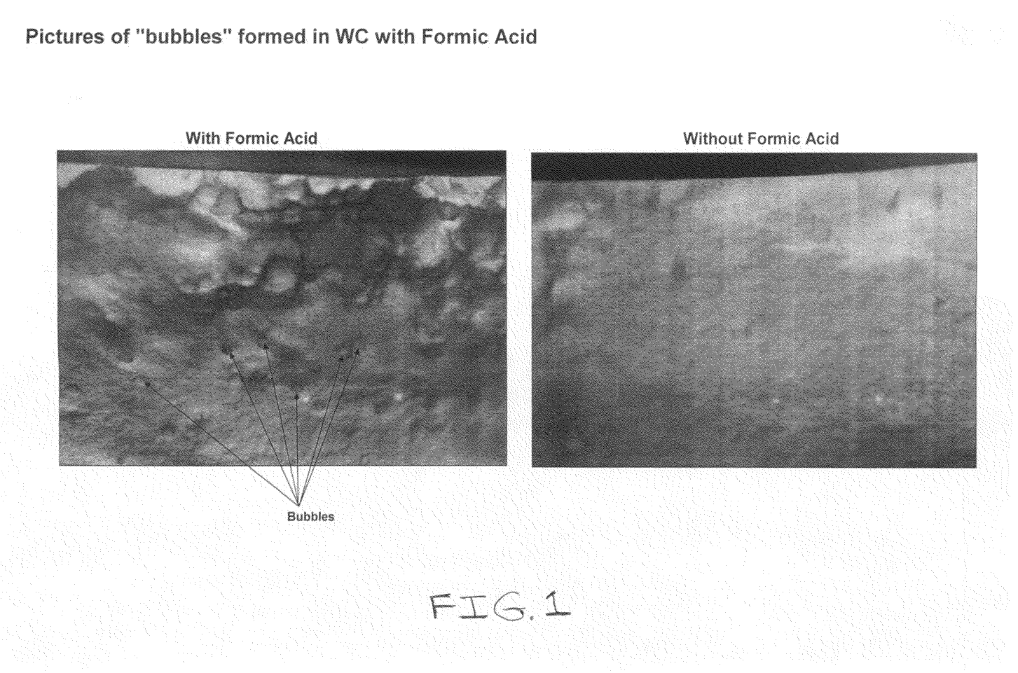

Without being limited to a particular theory, it is believed that the addition of formic acid to a washcoat slurry results in the formation of bubbles by the creation of CO₂ as carboxylic acid, preferably formic acid, is burned off and is thought to enhance resistance of the washcoat and/or overcoat to thermal shock after firing. It is also possible that the bubbles are formed in the slurry and captured in the immobilized slurry coating and retained as pores as the slurry is dried, which could happen before firing. FIG. 1 shows the formation of bubbles in a slurry with formic acid in comparison to no bubbles in a slurry without formic acid.

For example, formic acid can be broken down into H₂ and CO₂ in the presence of aluminum by the reaction

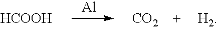

Formic acid also reacts with free aluminum to produce aluminum formate and hydrogen by the reaction Al+HCOOH→Al(OOCH)₃+H₂. Formic acid also reacts with alumina surface hydroxyl group to form polyaluminum formate, which increases the viscosity. H₂ and CO₂ are produced continuously in the slurry which will create random bubbles within the washcoat. In the prior art, washcoats are prone to cracks when subjected to a rapid change in temperature during thermal quenching (heat sample to the range of about 300° C. to about 500° C. and induce rapid temperature drop). In the present invention, it is believed, without being held to the mechanism, that these bubbles impart great resistance to crack propagation and help retain the strength within the washcoat which in turn helps the adhesion of the coating to the substrates.

After calcination of a washcoat comprising formic acid, a more uniform coating has been observed (less cracking of the washcoat). Without being limited to a theory, it is also believed that formic acid aids in drying and settling of the washcoat on a substrate. It appears that a slurry with formic acid is more resistant to thermal stresses.

Any washcoat and/or overcoat slurry having little to no platinum group metals may be used with this invention, preferably no platinum group metals.

Although the present invention has been described in terms of specific embodiments, changes and modifications can be made without departing from the scope of the invention which is intended to be defined only by the scope of the claims. All references cited herein are hereby incorporated by reference in their entirety, including any references cited therein.

What is claimed is:

1. A method for improving adhesion of a washcoat to a substrate, comprising:
adding a carboxylic acid to a slurry,
wherein the carboxylic acid is between about 0.1% to about 5% of a total oxide solid content of the slurry; and
exposing the substrate to the slurry.

2. The method of claim 1, wherein the carboxylic acid comprises one or more selected from the group consisting of glycolic acid, glyoxylic acid, carbonic acid, oxalic acid, acetic acid, and formic acid.

3. The method of claim 1, wherein the carboxylic acid is formic acid.

4. The method of claim 1, wherein the carboxylic acid is acetic acid.

5. The method of claim 1, wherein the carboxylic acid is between about 0.1% and about 3% of the total oxide solid content of the slurry.

6. The method of claim 1, wherein the carboxylic acid is between about 0.8% and about 1.5% of the total oxide solid content of the slurry.

7. A catalyst system, comprising:
a substrate; and
a washcoat,
wherein the washcoat is coupled with the substrate,
wherein the washcoat is made by the process comprising adding a carboxylic acid to a slurry comprising an oxide solid and exposing the substrate to the slurry, and
wherein the carboxylic acid is between about 0.1% to about 5% of a total oxide solid content of the slurry.

8. The catalyst system of claim 7, wherein the carboxylic acid comprises one or more selected from the group consisting of glycolic acid, glyoxylic acid, carbonic acid, oxalic acid, acetic acid, and formic acid.

9. The catalyst system of claim 7, wherein the carboxylic acid is formic acid.

10. The catalyst system of claim 7, wherein the carboxylic acid is acetic acid.

11. The catalyst system of claim 7, wherein the substrate is cordierite.

12. The catalyst system of claim 7, wherein the oxide solid comprises one or more selected from the group consisting of a carrier material oxide and a catalyst.

13. The catalyst system of claim 12, wherein the carrier material oxide comprises one or more selected from the group consisting of oxygen storage material, aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, and zeolite.

14. The catalyst system of claim 13, wherein the oxygen storage material comprises one or more oxides selected from the group consisting of cerium, zirconium, lanthanum, yttrium, lanthanides, and actinides.

15. The catalyst system of claim 12, wherein the catalyst comprises one or more selected from the group consisting of a platinum group metal and a transition metal.

16. The catalyst system of claim 15, wherein the platinum group metal comprises one or more selected from the group consisting of platinum, palladium, ruthenium, iridium, osmium, and rhodium.

17. The catalyst system of claim 15, wherein the transition metal comprises one or more selected from the group consisting of scandium, titanium, vanadium, chromium, manganese, iron, cobalt, nickel, copper, zinc, yttrium, zirconium, niobium, molybdenum, technetium, ruthenium, silver, cadmium, hafnium, tantalum, tungsten, rhenium, gold, mercury, rutherfordium, dubnium, seaborgium, bohrium, hassium, meitnerium, ununnilium, unununium, ununbium, and gallium.

18. The catalyst system of claim 7, wherein the carboxylic acid is between about 0.1% to about 3% of a total oxide solid content of the slurry.

19. The catalyst system of claim 7, wherein the carboxylic acid is between about 0.8% to about 1.5% of a total oxide solid content of the slurry.

20. A slurry for depositing a catalyst on a substrate, comprising:
an oxide solid; and
a carboxylic acid,
wherein the carboxylic acid is between about 0.1% to about 5% of a total oxide solid content of the slurry.

21. The slurry of claim 20, wherein the carboxylic acid comprises one or more selected from the group consisting of glycolic acid, glyoxylic acid, carbonic acid, oxalic acid, acetic acid, and formic acid.

22. The slurry of claim 20, wherein the carboxylic acid is formic acid.

23. The slurry of claim 20, wherein the carboxylic acid is acetic acid.

24. The slurry of claim 20, wherein the carboxylic acid is between about 0.1% and about 3% of a total oxide solid content of the slurry.

25. The slurry of claim 20, wherein the carboxylic acid is between about 0.8% and about 1.5% of a total oxide solid content of the slurry.

26. The slurry of claim 20, wherein the oxide solid comprises one or more selected from the group consisting of a carrier material oxide and a catalyst.

27. The slurry of claim 26, wherein the carrier material oxide comprises one or more selected from the group consisting of oxygen storage material, aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, and zeolite.

28. The slurry of claim 27, wherein the oxygen storage material comprises one or more oxides selected from the group consisting of cerium, zirconium, lanthanum, yttrium, lanthanides, and actinides.

29. The slurry of claim 26, wherein the catalyst comprises one or more selected from the group consisting of a platinum group metal and a transition metal.

30. The slurry of claim 29, wherein the platinum group metal comprises one or more selected from the group consisting of platinum, palladium, ruthenium, iridium, osmium, and rhodium.

31. The slurry of claim 29, wherein the transition metal comprises one or more selected from the group consisting of scandium, titanium, vanadium, chromium, manganese, iron, cobalt, nickel, copper, zinc, yttrium, zirconium, niobium, molybdenum, technetium, ruthenium, silver, cadmium, hafnium, tantalum, tungsten, rhenium, gold, mercury, rutherfordium, dubnium, seaborgium, bohrium, hassium, meitnerium, ununnilium, unununium, ununbium, and gallium.

32. A method for improving adhesion of an overcoat to a washcoat, comprising:
adding a carboxylic acid to a washcoat slurry,
wherein the carboxylic acid is between about 0.1% to about 5% of a total oxide solid content of the washcoat slurry; and
exposing a substrate to the washcoat slurry.

33. The method of claim 32, wherein the carboxylic acid comprises one or more selected from the group consisting of glycolic acid, glyoxylic acid, carbonic acid, oxalic acid, acetic acid, and formic acid.

34. The method of claim 32, wherein the carboxylic acid is formic acid.

35. The method of claim 32, wherein the carboxylic acid is acetic acid.

36. The method of claim 32, wherein the carboxylic acid is between about 0.1% and about 3% of a total oxide solid content of the washcoat slurry.

37. The method of claim 32, wherein the carboxylic acid is between about 0.8% and about 1.5% of a total oxide solid content of the washcoat slurry.

38. A method for improving adhesion of an overcoat to a washcoat, comprising:
adding a carboxylic acid to an overcoat slurry,
wherein the carboxylic acid is between about 0.1% to about 5% of a total oxide solid content of the overcoat slurry; and
exposing a washcoat to the overcoat slurry.

39. The method of claim 38, wherein the carboxylic acid comprises one or more selected from the group consisting of glycolic acid, glyoxylic acid, carbonic acid, oxalic acid, acetic acid, and formic acid.

40. The method of claim 38, wherein the carboxylic acid is formic acid.

41. The method of claim 38, wherein the carboxylic acid is acetic acid.

42. The method of claim 38, wherein the carboxylic acid is between about 0.1% and about 3% of a total oxide solid content of the overcoat slurry.

43. The method of claim 38, wherein the carboxylic acid is between about 0.8% and about 1.5% of a total oxide solid content of the overcoat slurry.

44. The method of claim 38, further comprising:
adding a carboxylic acid to a washcoat slurry;
wherein the carboxylic acid is between about 0.1% to about 5% of a total oxide solid content of the washcoat slurry; and
exposing a substrate to the washcoat slurry.

45. The method of claim 44, wherein the carboxylic acid comprises one or more selected from the group consisting of glycolic acid, glyoxylic acid, carbonic acid, oxalic acid, acetic acid, and formic acid.

46. The method of claim 44, wherein the carboxylic acid is formic acid.

47. The method of claim 44, wherein the carboxylic acid is acetic acid.

48. The method of claim 44, wherein the carboxylic acid is between about 0.8% and about 1.5% of a total oxide solid content of the washcoat slurry.

49. The method of claim 44, wherein the carboxylic acid is between about 0.8% and about 1.5% of a total oxide solid content of the overcoat slurry.

50. The method of claim 44, wherein the carboxylic acid is between about 0.1% and about 3% of a total oxide solid content of the washcoat slurry.

51. The method of claim 44, wherein the carboxylic acid is between about 0.1% and about 3% of a total oxide solid content of the overcoat slurry.

52. A method for improving adhesion of a slurry to a substrate, comprising:
adding a carboxylic acid to a slurry comprising an oxide solid,
wherein the carboxylic acid is between about 0.1% to about 5% of a total oxide solid content of said slurry; and
exposing the substrate to the slurry,
wherein about 120 g/L to about 180 g/L of the slurry is applied to a substrate.

53. The method of claim 52, wherein the carboxylic acid comprises one or more selected from the group consisting of glycolic acid, glyoxylic acid, carbonic acid, oxalic acid, acetic acid, and formic acid.

54. The method of claim 52, wherein the carboxylic acid is formic acid.

55. The method of claim 52, wherein the carboxylic acid is acetic acid.

56. The method of claim 52, wherein the carboxylic acid is between about 0.1% and about 3% of a total oxide solid content of the slurry.

57. The method of claim 52, wherein the carboxylic acid is between about 0.8% and about 1.5% of a total oxide solid content of the slurry.

58. The method of claim 52, wherein the oxide solid comprises one or more selected from the group consisting of a carrier material oxide and a catalyst.

59. The method of claim 58, wherein the carrier material oxide comprises one or more selected from the group consisting of oxygen storage material, aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, and zeolite.

60. The method of claim 59, wherein the oxygen storage material comprises one or more oxides selected from the group consisting of cerium, zirconium, lanthanum, yttrium, lanthanides, and actinides.

61. The method of claim 58, wherein the catalyst comprises one or more selected from the group consisting of a platinum group metal and a transition metal.

62. The method of claim 61, wherein the platinum group metal comprises one or more selected from the group consisting of platinum, palladium, ruthenium, iridium, osmium, and rhodium.

63. The method of claim 61, wherein the transition metal one or more selected from the group consisting of scandium, titanium, vanadium, chromium, manganese, iron, cobalt, nickel, copper, zinc, yttrium, zirconium, niobium, molybdenum, technetium, ruthenium, silver, cadmium, hafnium, tantalum, tungsten, rhenium, gold, mercury, rutherfordium, dubnium, seaborgium, bohrium, hassium, meitnerium, ununnilium, unununium, ununbium, and gallium.
